(19) United States
(12) Patent Application Publication
(10) Pub. No.: US 2010/0286898 A1
(43) Pub. Date: Nov. 11, 2010

(54) APPARATUS FOR SUPPLYING ROAD CONDITIONS

(75) Inventor: SHAN-JU LIN, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/614,574

(22) Filed: Nov. 9, 2009

(30) Foreign Application Priority Data
May 5, 2009 (CN) 200910302105.1

(51) Int. Cl. G08G 1/00; G06N 5/02

(52) U.S. Cl. 701/119; 706/54

(57) ABSTRACT

An exemplary apparatus for supplying road conditions includes a detector, an information processing device, and a transmission device. The detector configured to detect current road conditions. The information processing device communicatively coupled to the detector for receiving information on the current road conditions. The information processing device stores predetermined information on road conditions and configured for comparing with the predetermined road conditions to obtain a comparison result. The transmission device communicatively coupled to the information processing device and configured for transmitting the comparison result to a predetermined recipient.

### BACKGROUND

1. Technical Field

The present disclosure relates to an apparatus for supplying information on road conditions to one or more users, and particularly to an apparatus which can analyze the road conditions automatically and generate an analysis result for supply to such users.

2. Discussion of Related Art

A good road conditions processing system provides great convenience to users. There is a lot of research and development in the field of road conditions processing.

To insure traffic safety, various apparatuses for detecting and supplying road conditions are employed. For example, detected road conditions are displayed by the roadside in real time for the assistance of drivers. However, road condition displays are only provided at certain roadside or other specific locations, and thus road conditions may not be known to drivers at all times. Generally, these kinds of apparatuses only supply simple information on road conditions to users such as drivers, with little or no gathering of detailed information on road conditions or analysis of the significance of such detailed information. Therefore the information provided to users may be of limited assistance and in some cases may even be misguiding.

Therefore, an apparatus for supplying road conditions is desired to overcome the shortcomings described above.

### BRIEF DESCRIPTION OF THE DRAWINGS

Many aspects of the disclosure can be better understood with reference to the following drawings. The components in the drawings are not necessarily to scale, the emphasis instead being placed upon clearly illustrating the principles of the disclosure. Moreover, in the drawings, like reference numerals designate corresponding parts throughout the several views.

FIG. 1 is a block diagram of an apparatus for supplying road conditions, in accordance with a first embodiment.

FIG. 2 is a block diagram of an apparatus for supplying road conditions, in accordance with a second embodiment.

### DETAILED DESCRIPTION

Reference will now be made to the drawings to describe in detail exemplary embodiments of the apparatus for supplying road conditions.

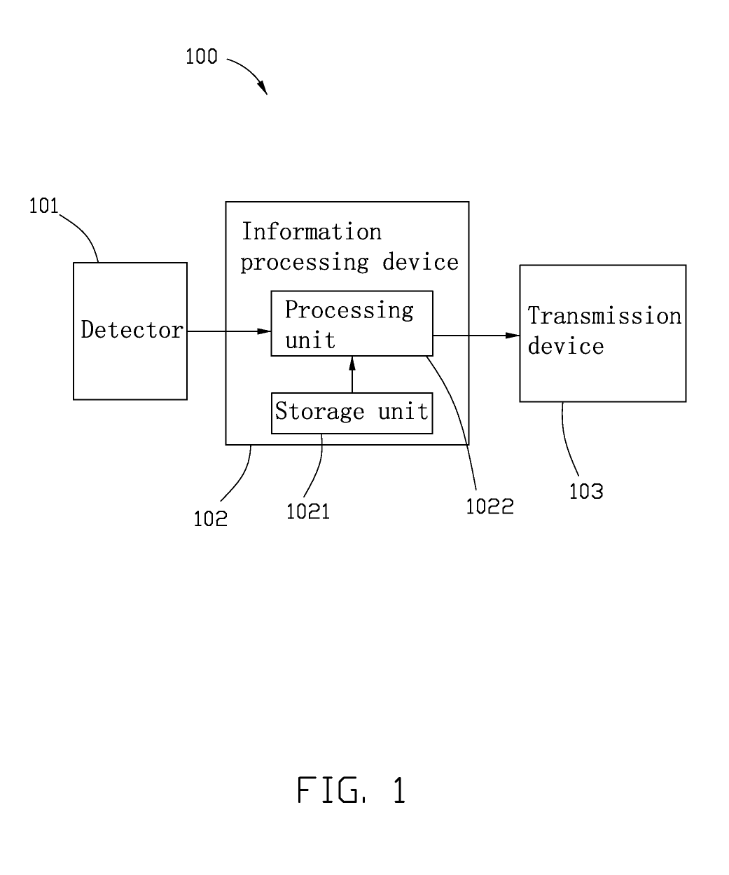

Referring to FIG. 1, an apparatus for supplying road conditions 100, in accordance with a first embodiment, includes a detector 101, an information processing device 102 and a transmission device 103.

The detector 101 is configured to detect current road conditions, and transmit information on the road conditions to the information processing device 102. The current road conditions include, for example, vehicle speeds and distances between vehicles. The detector 101 is selected from the group consisting of an infrared sensor, an electromagnetic wave sensor, and a sound wave sensor. In the present embodiment, the detector 101 is an electromagnetic wave sensor. The electromagnetic wave sensor is adapted to transmit electromagnetic waves, detect reflection of the electromagnetic waves, and thereby ascertain positions of vehicles and changes in the positions of vehicles. The electromagnetic wave sensor is therefore able to acquire vehicle speeds and distances between vehicles. The electromagnetic wave sensor can for example be a traffic radar.

The information processing device 102 is communicatively coupled to the detector 101 to receive the information on the current road conditions. The information processing device 102 includes a storage unit 1021 and a processing unit 1022.

The storage unit 1021 stores predetermined reference road conditions, for 110 example, predetermined vehicle speeds and predetermined distances between vehicles in respect of different sections of road. In the present embodiment, the storage unit 1021 can compress and quantize the different predetermined vehicle speeds and different predetermined distances between vehicles to different first binary codes. Each first binary code represents a particular traffic state, such as a traffic jam or smooth traffic flow.

The processing unit 1022 is communicatively coupled to the storage unit 1021, and communicatively coupled to the detector 101 to receive the current road conditions. In the present embodiment, the processing unit 1022 can compress and quantize the current road conditions to a second binary code. The processing unit 1022 compares the second binary code with the first binary codes, and determines the current state of traffic (e.g. a traffic jam, smooth traffic flow, etc) according to the comparison result. In this embodiment, the information processing device 102 is an embedded computer system. Such embedded computer system has a short interrupt response time, so that the corresponding first binary code can be identified in a short time.

The information processing device 102 can also determine the current state of traffic by other means, for example by directly comparing the current road conditions with the predetermined road conditions stored in storage unit 1021. For instance, the predetermined road conditions stored in the storage unit 1021 include predetermined vehicle speeds and predetermined distances between vehicles during smooth traffic conditions. When the current vehicle speeds and the current distances between vehicles are equal to or greater than the predetermined vehicle speeds and distances between vehicles, the traffic is smooth. When the current vehicle speeds and the current distances between vehicles are less than the predetermined vehicle speeds and distances between vehicles, the traffic is jammed. If one of the current vehicle speeds and distances between vehicles is equal to or greater than the respective predetermined vehicle speeds and distances between vehicles while the other is less, the traffic is in rush hour.

The transmission device 103 is communicatively coupled to the processing unit 1022 of the information processing device 102, and is used to transmit the traffic state to a receiver, such as a road conditions monitoring center. In the present embodiment, the transmission device 103 is a wireless transmission device, such as a device operable for worldwide interoperability for microwave access (WiMAX), a wireless local area network (WLAN), Wi-Fi™, Bluetooth™, or infrared signal transmission.

In summary, the apparatus for supplying road conditions 100 can receive and analyze current road conditions automatically, and deliver information on the current state of traffic to a receiver instantly and accurately.

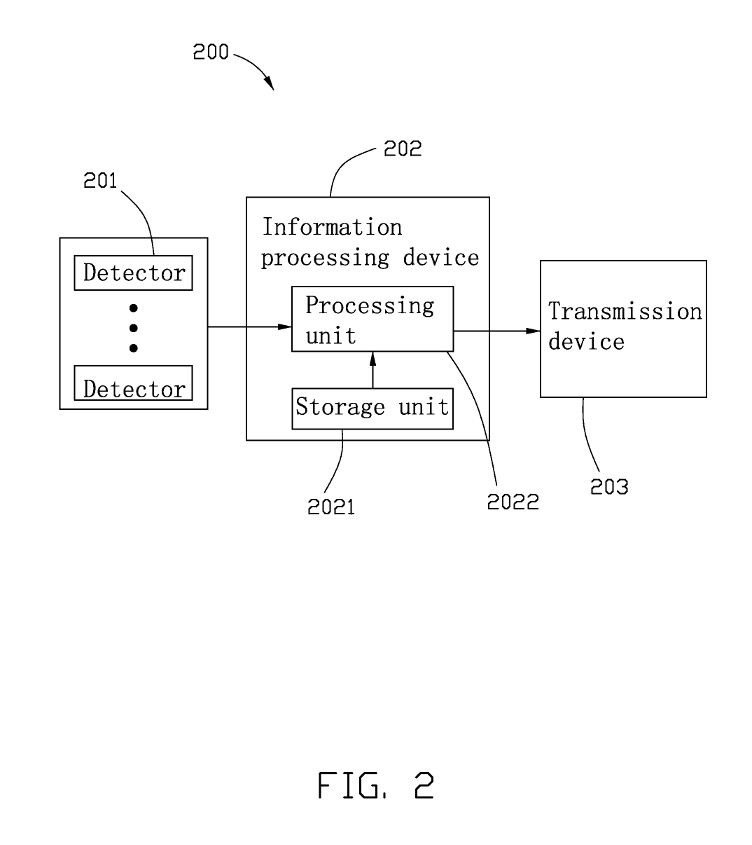

Referring to FIG. 2, this shows an apparatus for supplying road conditions 200 in accordance with a second embodiment. The apparatus for supplying road conditions 200 is distinguished from the apparatus for supplying road conditions 100 in that it includes a plurality of detectors 201.

The detectors 201 are adapted to detect current road conditions, and deliver information on the road conditions to the information processing device 202. The information processing device 202 includes a storage unit 2021 and a processing unit 2022. The storage unit 2021 stores predetermined reference road conditions. The processing unit 2022 is communicatively coupled to the storage unit 2021 to receive the predetermined road conditions, and communicatively coupled to the detectors 201 to receive the current road conditions. The processing unit 2022 compares the current road conditions with the predetermined road conditions, determines the current state of traffic according to comparison result, and transmits information on the current traffic state to the transmission device 203.

The detectors 201 can detect current road conditions on a large scale to help ensure accuracy of the information.

It is to be understood, however, that even though numerous characteristics and advantages have been set forth in the foregoing description of embodiments, together with details of the structures and functions of the embodiments, the disclosure is illustrative only; and that changes may be made in detail, especially in matters of arrangement of parts within the principles of the disclosure to the full extent indicated by the broad general meaning of the terms in which the appended claims are expressed.

What is claimed is:

1. An apparatus for supplying road conditions, the apparatus comprising:
a detector configured to detect current road conditions;
an information processing device communicatively coupled to the detector for receiving information on the current road conditions, the information processing device storing predetermined information on road conditions and configured for comparing the information on the current road conditions with the predetermined information on road conditions to obtain a comparison result; and
a transmission device communicatively coupled to the information processing device and configured for transmitting the comparison result to a predetermined recipient.

2. The apparatus of claim 1, wherein the detector is selected from the group consisting of an infrared sensor, an electromagnetic wave sensor, and a sound wave sensor.

3. The apparatus of claim 1, wherein the instant road conditions comprises vehicle speed.

4. The apparatus claim 1, wherein the instant road conditions comprises distance between vehicles.

5. The apparatus of claim 1, wherein the transmission device is a wireless transmission device.

6. The apparatus of claim 1, wherein the information processing device comprises embedded computer system.

7. The apparatus of claim 1, wherein the information processing device comprises a storage unit and a processing unit, the storage unit is adapted to store predetermined information on road conditions, the processing unit is adapted to compare the information on the current road conditions with the predetermined information on road conditions to obtain a comparison result.

8. The apparatus of claim 7, wherein the storing unit compress and quantize the predetermined road conditions to a first binary code, and the processing device compress and quantize the current road conditions to a second binary code and compare with the first binary code to obtain a comparison result.

9. An apparatus for supplying road conditions, the apparatus comprising:
a detector configured to detect current vehicle speeds and distances between vehicles;
an information processing device comprising a storage unit and a processing unit, the storage unit storing predetermined information on vehicle speeds and predetermined information on distances between vehicles in respect of different sections of road during smooth traffic conditions, the processing unit communicatively coupled to the storage unit and the detector, and configured for receiving information on the current vehicle speeds and current distances between vehicles, and for comparing the information on the current vehicle speeds and current distances between vehicles with the predetermined information on vehicle speeds and distances between vehicles, respectively, to obtain a comparison result; and
a transmission device communicatively coupled to the processing unit of the information processing device and configured for transmitting the comparison result to a predetermined recipient.

10. An apparatus for supplying road conditions, the apparatus comprising:
a plurality of detectors configured to detect current road conditions;
an information processing device communicatively coupled to the detectors for receiving information on the current road conditions, the information processing device storing predetermined information on road conditions and configured for comparing the information on the current road conditions with the predetermined information on road conditions to obtain a comparison result; and
a transmission device communicatively coupled to the information processing device and configured for transmitting the comparison result to a predetermined recipient.

11. The apparatus of claim 10, wherein the instant road conditions comprises vehicle speed.

12. The apparatus of claim 10, wherein the instant road conditions comprises distance between vehicles.
